(19) United States
(12) Patent Application Publication
(10) Pub. No.: US 2024/0237585 A1
(43) Pub. Date: Jul. 18, 2024

(54) METHOD FOR SEMI-AUTONOMOUSLY PROCESSING PLANTS

(71) Applicant: ROBOTEC PTC GMBH, Bremen (DE)

(72) Inventors: Stephan VON RUNDSTEDT, Bremen (DE); Friederike VON RUNDSTEDT, Bremen (DE); Adrian LEU, Bremen (DE)

(73) Assignee: ROBOTEC PTC GMBH, Bremen (DE)

(21) Appl. No.: 18/564,190

(22) PCT Filed: May 6, 2022
(86) PCT No.: PCT/EP2022/062280

§ 371 Date: Dec. 26, 2023

(30) Foreign Application Priority Data
May 26, 2021 (DE) 10 2021 113 533.8

(51) Int. Cl. A01G 2/32; A01C 1/06; A01G 2/10; A01G 7/04; A01G 7/06

(52) U.S. Cl. CPC A01G 2/32; A01C 1/06; A01G 2/10; A01G 7/045; A01G 7/06

(57) ABSTRACT

A method by means of which the processing of plants can be carried out in a more time- and cost-efficient manner. For this purpose, at least one plant or a component of the plant is detected by an image-recognition device. Using the patterns and features of the plants recognized by the image-recognition device, at least one option for processing the plant is suggested to a person. Upon selection of at least one option by the person, the plant or the component of the plant is autonomously or automatically processed by a processing means.

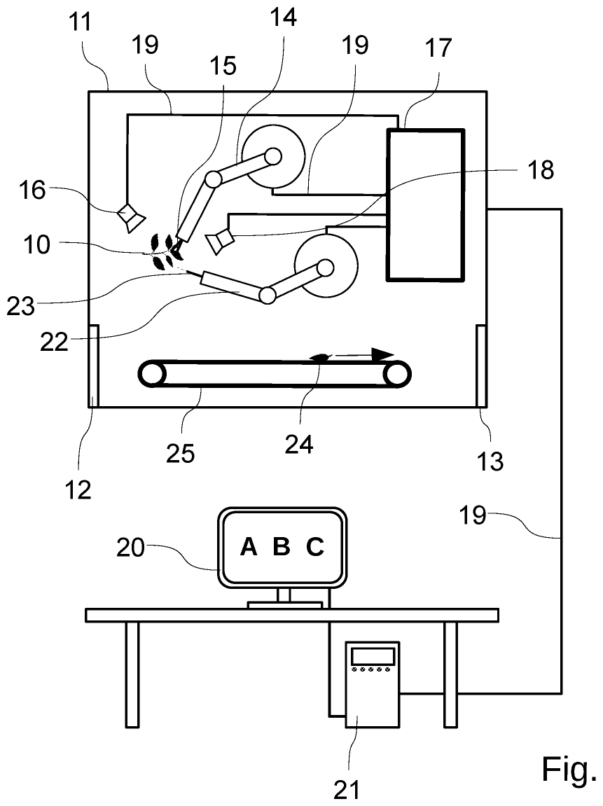

The invention relates to a method for semi-autonomous processing of plants as claimed in claim 1.

The generative and vegetative propagation of plants and plant culturing in artificial culture systems, such as for example tissue culturing, includes all methods of cultivating and cloning plant cells, organ parts and embryos of plants for certain purposes under in vivo and in vitro conditions.

The principles of generative propagation of plants are based on sexual reproduction (crossbreeding) of two different plants in order to obtain seeds (seeding material) for the production of offspring. Here, selective breeding operations are carried out on plants or also on certain organs or for example in the endosperm or the germ cells.

The principles of vegetative propagation are based on the division, cloning and grafting of plants. Both the propagation of cuttings and plant tissue culturing are based on the principle of the fundamental totipotency of each plant cell. One of the aims of these methods is to produce a complete and genetically identical plant (clone) from an explant (usually a piece of plant tissue). In the propagation of cuttings, for this purpose, tissues are separated from a mother plant in a non-sterile environment. In in vitro culturing, the cells of the explant multiply in a sterile environment on a nutrient medium with the addition of plant hormone, nutrients and light and form roots, leaves, other organs, or cells as part of adventitious organogenesis.

For all these processes, manual, surgical interventions on the plant material have been necessary in the past at various points in the vegetative and generative propagation process. These are carried out primarily in a sterile, but in some cases also in a non-sterile environment using various treatment means such as tweezers, scalpels, cutting shears, preparation tools, the human hand, etc. In many cases, microscopes or further magnifying aids are also used for these processes. If these processes are carried out under sterile conditions, this is done in a clean room or on sterile workbenches.

For economical cultivating and production processes, in which these treatment processes or operations are carried out on the plant material, it is very important for the plants to be free of pathogens and, at least in part, to be explicitly treated in a restorative manner (to eliminate pathogens). This is achieved by sterilizing the treatment means or surgical instrument and disinfecting all surfaces and materials with which the plant material to be treated comes into contact. This is very expensive, in particular with a high throughput of plants to be treated.

The object of the invention is therefore to provide a method by means of which the processing of plants can be carried out in a more time- and cost-efficient manner.

A solution to this problem is described via the measures of claim 1. According to this claim, a method is provided for semi-autonomous processing of plants in which at least one plant or a component of the plant is detected by image recognition. Using the patterns and features of the plants recognized by the image-recognition device, at least one option for processing the plant is suggested to a person. On selection of at least one option by the person, the plant or the component of the plant is/are then autonomously or automatically processed by a processing means. This method for processing of the plant is thus divided into autonomous machine-controlled handling of the plant and image recognition, with which the specific features of the plant are recognized, and a decision-making process that is carried out by one person. The person thus determines which operation or which treatment is to be carried out on the plant. Here, the possible operations or treatments are selected from multiple options, which are made available by a control unit or a computer on the basis of the recognized pattern. The person therefore no longer needs to manually handle the plant. This allows the actual operation or treatment of the plant to take place at a remote location separate from the person. In particular, this facilitates the necessary sterilization or disinfecting of the environment in which processing of the plant is carried out. This allows the entire process to be carried out in a particularly time- and cost-efficient manner. The plants or plant components described here can also be plant organ parts or other plant material. Accordingly, the method described here should not be restricted to use on a plant, but should also extend to use on plant organ parts and the like.

Preferably, the invention further provides that the plant hanging or lying on a substrate is detected by the image-recognition device from at least one perspective, preferably from all sides, and with the aid of a neural network or an algorithm, features and patterns are recognized, and based on these features and patterns, at least one option, preferably a large number of possible processing options, is/are shown. The use of a neural network not only makes it possible to recognize each individual plant, but also to determine feasible and appropriate options for treating the plant. It is conceivable here for the type of treatment to be carried out to be specified in advance for the neural network by a control unit. The neural network then for example looks for suitable sites on the plant for taking a sample or conducting cutting in order to produce a clone of the plant. Moreover, it is equally conceivable that while the method is being carried out, the neural network is continuously expanded and learns something new with each process step. The high accuracy and speed of the pattern recognition thus makes it possible to show the person a large number of different treatment options. Likewise, it is conceivable that the neural network recognizes that the operation or known treatment processes are not suitable and the plant is to be removed from the process. However, such a situation could also be used to establish a new treatment process and to use the neural network accordingly. The image-recognition device can comprise one, two or more cameras. These cameras are or can be positioned in such a manner that they can record images of the plant from at least one perspective, and preferably from all perspectives. The camera can be an optical system with a light-sensitive sensor, for example a CCD chip or a CMOS sensor that is sensitive to different spectral ranges. In addition, it is also conceivable that the image-recognition device is equipped with further sensors, such as for example a weight sensor or a sensor for measuring the size of the plant.

The possible processing options or operations can be cutting the plant, cloning, sampling, meristemization, micrografting, selective processing of the plant tissue, growth stimulation, disruption of dormancy by perforating a seed coat, processing and treatment of seeds, seed coats, embryos, zygotes, proembryos, processing and treatment of plant organs for in vitro culture, such as meristem, axillary buds, root tips, leaf and peduncle pieces, adventitious shoots, callus cultures, solitary cells, microspores, ovary, anthers, pollen, fruits and microcuttings and the like. In addition, other operations or treatments of plants are possible. Ultimately, it is conceivable that any operation or treatment of plants is carried out semiautonomously in the manner described here.

In particular, it is provided that processing of the plant takes place in a sterile or non-sterile environment, wherein the at least one plant, in particular automatically or manually, is transported into the sterile environment and, in particular automatically or manually, back out of the sterile environment. It is conceivable that the plant is transported through locks when it enters and exits the sterile environment. This reduces the expense of sterilization or decontamination before each processing step. Sterilization or decontamination of the room in which the treatment is carried out is conducted using known measures.

A further advantageous exemplary embodiment of the invention can provide that the person selects a processing option for the plant and is then shown by the control device, preferably by means of a projection or a laser marking on the plant, where and/or how the plant is to be processed. It is also conceivable, for example, that the control device projects a patten on the plant, which is then automatically cut by a cutting means or by the person. This machine-assisted method makes it possible to carry out processing of the plant in a particularly precise and efficient manner. It can at the least almost completely be ruled out that the wrong cut or treatment is selected, which usually causes the treated plant to become unusable.

In addition, it can also be provided that the person selects a processing option for the plant and this is then carried out by the processing means, which can be scissors, a scalpel, a laser beam, a plasma jet, a water jet, tweezers, forceps, a spatula, or a holding, grasping, holding and clamping, cutting, bringing together, inspection-suitable, endoscopic, or also combined instrument or the like. The corresponding processing means is moved by a robot arm that is freely moveable in a three-dimensional space in such a way that it carries out the previously-displayed treatment on the plant. Likewise, it is conceivable that the selected treatment is carried out by multiple processing means, each of which is attached to a robot arm. For example, an exemplary embodiment can provide that the plant, which is hanging in a gripper, is moved in a specific way by tweezers in order to make a targeted cut using a cutting means. The use of other processing means is also conceivable. In the micrografting process, after the parts of the plant (scion and rootstock) have been brought together, a silicone clip, for example, is attached to connect the parts until they have grown together. This can also be carried out by the above-mentioned processing means or tools. Another processing example is the restoration or activation of a plant or a plant component by means of a laser or a plasma. In addition, there is a large number of other possibilities for processing the plant and the components with the processing means used here.

A further preferred exemplary embodiment can provide that the processed plant or the processed component of the plant is removed after processing manually or by a conveyer or a gripping means. The plant or the component is further supplied to a nutrient medium and discharged. Alternatively, the plant is first discharged and then further processed. For further processing, the plant can be placed for example in a nutrient medium.

It is preferably provided that the processed plant or the processed component of the plant is again detected by an image-recognition device and the person is shown at least one option for further processing, wherein the further processing can in particular be a further treatment as claimed in claim 3, a disposal, or a delivery of the plant or the component to a nutrient medium.

Furthermore, it can be provided according to the invention that the person is spatially separated from the device for carrying out processing of the plant in a non-sterile environment. Here, it is conceivable that the person, on an imaging device such as for example a monitor, a tablet or a smartphone, can select the desired option from the large number of possible options for processing the plant. In addition, it is also conceivable that the person carries out the options suggested by the control unit for processing the plant with the aid of virtual reality devices, preferably VR glasses or VR gloves. In the latter case, the gripper or the robot arm with the treatment means follows the movement carried out by the person by means of the VR glove.

A particular advantage is that at the least, the person need not be in direct proximity to the device by which the treatment is carried out. It is thus conceivable that there is a distance of multiple kilometers or even hundreds of kilometers between the person and the actual treatment of the plant. In this manner, it is possible to carry out monitoring or control of the treatment process in a manner that is locally decoupled from the actual treatment process. This local decoupling can have a particularly time- and cost-saving effect. For the actual process actions on the plant, only the device with the image-recognition devices and the treatment means has to be provided, while in order to operate the device, people only need access to a network in order to remotely control the process. In fact, in this manner, the method can be carried out independently of the person's location.

By means of this method according to the invention, it is also conceivable that the person simultaneously monitors or controls multiple treatment processes of multiple plants via the imaging device. In particular, if the same or at a least a similar treatment process is to be carried out simultaneously on a large number of plants, this can be controlled and monitored by a single person. This reduces the number of people required to carry out the method for processing plants.

Preferably, it is also conceivable that the options for processing of the plant are suggested to the person in a prioritized order, wherein depending on the recognized patterns and features of the plant, processing options that are carried out with particular frequency are suggested first. This pre-selection or weighting of the possible processing options makes it possible to configure the selection of the desired treatment in a highly time-efficient manner. The person does not need to first conduct a lengthy search for the desired treatment of the plant; rather, a treatment option is suggested to the person that in all likelihood is the desired one. The neural network also provides the information necessary for this pre-selection.

In a further alternative exemplary embodiment, certain options for treatment can be automatically carried out by the control unit for selected recognized patterns and features of the plant, in particular for a damaged or wrong plant. The operator therefore no longer needs to intervene in the process; rather, the method would be a fully autonomous processing of the plant. This is conceivable in particular for simple process steps that do not need to be monitored by the person. In this alternative, the neural network recognizes the treatment to be carried out and does so without further confirmation by the person. As soon as the situation changes, for example because a different treatment is advised for the plant, either a corresponding signal can be given or a corresponding different treatment method can be carried out.

The present invention provides that the at least one processing means is controlled by an artificial intelligence (AI), wherein the neural network of the AI accesses a constantly expanding database of a large number of images of plants and various processing options as claimed in claim 3. The constantly expanding database of various patterns makes it possible to continuously improve the processing. In this manner, it becomes possible to achieve highly precise and reliable processing of the plant. Moreover, because of the high degree of automation, this method is also characterized by being highly time- and cost-efficient.

A preferred exemplary embodiment of the invention is described in further detail below with reference to the single FIGURE. The FIGURE shows:

FIG. A schematic representation of the method.

In the FIGURE, the method according to the invention is described by way of example and in a highly schematic manner. The basic idea of the invention is that for the processing of a plant 10, various options for the processing thereof are suggested to a person, wherein these options are determined by an image-recognition device and a neural network. The option selected by the person is then carried out on the plant 10 using a processing means.

For processing, the plant 10, which can also be an individual component of the plant 10, is guided into an open or closed operating room 11. This operating room 11 can be either sterile or non-sterile. For the variant in which the operating room 11 maintains a sterile atmosphere, the plant 10 can be transported through a lock 12 into the room 11, and after completion of processing, again leave the room 11 through a lock 13. The plant 10 can be transported into the room as an individual or loose plant 10 or in a container such as e.g. a culture vessel. The plant 10 can be located on a conveyor (not shown) such as a belt conveyor. The plant 10 is then detected on this conveyor by an image-recognition device (not shown) and a location is determined at which the plant 10 can be grasped in a particularly easy and gentle manner. The plant 10 is gripped by a gripper 14. This gripper 14 can for example be a robot arm that is moveable in a three-dimensional space. Likewise, the gripper 14 can be only a gripping means 15 that can be moved up and down in one dimension. The gripping means 15 can for example be tweezers, a suction cup or the like.

The plant 10 is guided by the gripper 14 in front of at least one camera 16 of an image-recognition device. In the exemplary embodiment shown in the FIGURE, the image-recognition device is integrated into a control unit 17. In order to obtain an image of the plant 10 that is as complete as possible, it can be provided that the plant 10 is rotated by the gripper 14 in front of the camera 16. Alternatively, it is also conceivable that the image-recognition device comprises at least one further camera 18 that records the plant 10 from another perspective.

Both the cameras 16, 18 and the gripper 14 are connected to the control unit 17 via corresponding lines 19. The image-recognition device or the control unit 17 then determines based on the pictures taken of the plant 10 an image of the plant 10 and possible operations or processing options for this individual plant 10. The AI, which recognizes features and patterns of this individual plant 10 with the aid of a neural network and creates multiple options for the further processing of the plant based on a database, is used for this purpose.

Likewise, it is conceivable that the AI recognizes no possible option or only one. For example, it is conceivable that the AI recognizes that the plant is unsuitable for further processing due to damage and is therefore to be discarded. The various options for the processing can for example be cutting of the plant 10, cloning, sampling, meristemization, micrografting, selective processing of the plant tissue, growth stimulation, irradiation of the plant 10, disruption of dormancy by perforating a seed coat, processing and treatment of seeds, seed coats, embryos, zygotes, proembryos, processing and treatment of plant organs for in vitro culture, such as meristem, axillary buds, root tips, leaf and peduncle pieces, adventitious shoots, callus cultures, solitary cells, microspores, ovary, anthers, pollen, fruits and microcuttings and the like. It should be expressly indicated that this enumeration is not to be understood as exhaustive; rather, it is provided that further processing options are also conceivable. The type of option shown depends greatly on the type of the plant 10 and its nature. It is also to be provided that various options to be preferred are shown by the control unit 17. As a result, the AI only checks whether or not these predetermined options are feasible or not.

During implementation of the method, the AI continues to learn. This means that due to the large number of individual plants and the treatments carried out, the database of the neural network is permanently expanded, thus further increasing the accuracy and efficiency of the neural network. In addition, it is also conceivable that the control unit 17 accesses further databases in order to learn new options or processing possibilities.

As soon as the AI has determined at least one option for the further processing of the plant 10, the person is presented with this at least one option for selection. The FIGURE shows how three different treatment options A, B and C are displayed on a monitor 20. For this purpose, the corresponding data are fed from the control unit 17 to an external computer 21, which is in turn connected to the monitor 20. The person (not shown) can then decide whether the plant 10 is to be processed according to option A, option B or option C. In addition to options A, B and C shown here in a highly schematic manner, the person also receives further information with respect to the possible options. It is also conceivable that only one option or a large number of options, such as for example 10, 20 or even more options, is/are displayed on the monitor 20.

The order of the suggested options can be determined by weighting. This weighting is based on the frequency of the selected options or a match between the sample recognized by the neural network and preset example patterns. A further alternative use can provide that the person always selects option B. In the case of this selection, the next plants 10 will exclusively be processed according to option B. Semiautonomous processing of the plants can therefore be converted, at least in the short term, into completely autonomous processing.

After selection of a specified option, the control unit 17 receives the corresponding signal from the computer 21, whereby a processing means 22 is correspondingly controlled by the control unit 17 and the plant 10 is processed according to the option selected. The processing means 22, as shown in the FIGURE by way of example, can be a laser 23. Likewise, however, the processing means 22 can also be scissors, a scalpel, a plasma jet, a water jet, tweezers, forceps, a spatula or the like. In the exemplary embodiment shown in the FIGURE, the laser 23 is attached to a robot arm, whereby the laser 23 is moveable in a three-dimensional space. This allows the processing means 22 to be moved exactly to the position relative to the plant 10 in order to carry out the selected processing options.

Exemplary embodiments are also conceivable in which multiple processing means 22 are used in order to carry out more complicated treatments, for example in combination with pliers and scissors. In such a case, both processing means would then comprise a corresponding robot arm.

The processed plant and/or the separated plant component 24 is transported away on a conveyor belt 25 after processing. In the exemplary embodiment shown in the FIGURE, the plant component 24 is transported in the direction of the lock 13. Alternatively, it is also conceivable that the plant component 24 is gripped by a further gripping means (not shown) and placed in a nutrient medium.

The present invention allows the person to sit remotely from the operating room 11 in front of the monitor 20 and select the suggested options. The computer 21 is thus connectable to the control unit 17 via the internet. The method described here can thus be carried out with the corresponding software from virtually any desired location in the world.

In addition to the conventional input method via a computer 21 presented here and selection on a monitor 20, it is also conceivable that the person selects the specified options via VR glasses and VR gloves or via an augmented reality technology and also directly controls the gripping means 15 or the processing means 22. It is thus conceivable that the person grips the plant 10 via virtual reality and processes the plant 10 using the processing means 22. The advantage here is that processing can take place in a sterile environment, while the person with the VR glasses and the VR gloves can also be in any desired and thus non-sterile room. As a result, the entire process of processing plants may configured to be extremely time- and cost-intensive.

### LIST OF REFERENCE NUMBERS

10 plant
11 operating room
12 lock
13 lock
14 grippers
15 gripping means
16 camera
17 control unit
18 camera
19 line
20 monitor
21 computer
22 processing means
23 laser
24 plant component
25 conveyor belt

1. A method for semiautonomous processing of plants with at least one processing means, wherein at least one plant or a component of a plant is detected by an image-recognition device and at least one option for processing of the plant is suggested to a person based on the recognized features of the plant, and wherein after selection of an option by the person, the plant is processed by the processing means.

2. The method as claimed in claim 1, wherein the plant hanging or lying on a substrate is detected by the image-recognition device from at least one perspective, and with the aid of a neural network or an algorithm, features and patterns are recognized, and based on these features and patterns, at least one option is shown.

3. The method as claimed in claim 1, wherein the possible processing operations are cutting the plant, cloning, sampling, meristemization, micrografting, selective processing of the plant tissue, growth stimulation, irradiation of the plant for bioactivation and/or pathogen elimination, disruption of dormancy by perforating a seed coat, processing and treatment of seeds, seed coats, embryos, zygotes, proembryos, processing and treatment of plant organs for in vitro culture, such as meristem, axillary buds, root tips, leaf and peduncle pieces, adventitious shoots, callus cultures, solitary cells, microspores, ovary, anthers, pollen, fruits and microcuttings and the like.

4. The method as claimed in claim 1, wherein the processing of the plant takes place in a sterile or in a non-sterile environment.

5. The method as claimed in claim 1, wherein the person selects a processing option of the plant and is then shown by a control device where and/or how the plant is to be processed.

6. The method as claimed in claim 1, wherein the person selects a processing option of the plant, and this is then carried out by the processing means, which can be scissors, a scalpel, a laser beam, a plasma jet, a water jet, tweezers, forceps, a spatula, or a holding, grasping, holding and clamping, cutting, bringing together, inspection-suitable, endoscopic, or also a combined instrument or the like.

7. The method as claimed in claim 1, wherein the processed plant or the processed component is removed after processing manually or by a conveyer or a gripping means.

8. The method as claimed in claim 1, wherein the processed plant or the processed component of the plant is detected by an image-recognition device and the person is shown at least one option for further processing.

9. The method as claimed in claim 1, wherein the person is spatially separated from the device for carrying out processing of the plant in a non-sterile environment.

10. The method as claimed in claim 1, wherein the person can select the desired option from the large number of possible options for processing the plant on an imaging device.

11. The method as claimed in claim 1, wherein the person carries out the options for processing the plant suggested by the control unit with the aid of virtual reality devices.

12. The method as claimed in claim 1, wherein the options for the processing of the plant are suggested to the person in a prioritized order, wherein depending on the recognized patterns and features of the plant, the processing options that are selected particularly often are suggested first.

13. The method as claimed in claim 1, wherein the at least one processing means and further surfaces are automatically sterilized and/or disinfected before each processing of a plant and/or before each new processing step.

14. The method as claimed in claim 1, wherein the person simultaneously monitors and controls multiple treatments of plants via an imaging device.

15. The method as claimed in claim 1, wherein certain options are automatically carried by the control unit for selected recognized patterns and features of the plant.

16. The method for semiautonomous processing of plants with at least one processing means, wherein at least one plant or a component of a plant is detected by an image-recognition device and at least one option for processing of the plant is suggested to a person based on the recognized features of the plant, and wherein after selection of an option by the person, the plant is processed by the processing means, wherein the processing means is controlled by an artificial intelligence, wherein the neural network accesses a constantly expanding database of a large number of images of plants and the various processing options as claimed in claim 3.
